(19) United States
(12) Patent Application Publication
(10) Pub. No.: US 2005/0214691 A1
(43) Pub. Date: Sep. 29, 2005

(54) Method of manufacturing multilayer optical information recording medium, and multilayer optical information recording medium

(76) Inventor: Takanobu Higuchi, Tsurugashima-shi (JP)

Correspondence Address: MCGINN & GIBB, PLLC, 8321 OLD COURTHOUSE ROAD, SUITE 200, VIENNA, VA, 22182-3817, US

(21) Appl. No.: 11/086,988

(22) Filed: Mar. 23, 2005

(30) Foreign Application Priority Data
Mar. 29, 2004 (JP) 2004-095853

(51) Int. Cl. G03C 5/00; B29D 17/00

(52) U.S. Cl. 430/321; 264/1.33

(57) ABSTRACT

The invention relates to a method of manufacturing a multilayer optical disc which is not formed with voids in an optically transparent zone, and a multilayer optical disc. The method of manufacturing a multilayer optical information recording medium having at least a first and a second information recording layer includes the steps of forming the first information recording layer, applying a porous resin film on the first information recording layer, impregnating the porous resin film with a liquid functional resin, bringing a stamper into pressure contact with the porous resin film and curing the functional resin, and removing the stamper so that the second information recording layer is formed on the substrate.

### BACKGROUND OF THE INVENTION

1. Field of the Invention

The present invention relates to a method of manufacturing a multilayer optical information recording medium, and a multilayer optical information recording medium.

2. Description of the Related Art

A multilayer optical information recording medium including a plurality of recording layers has been proposed as one means for achieving a larger capacity optical information recording media, such as optical discs.

Among multilayer optical information media, two-layer optical disc has a substrate including a first information recording layer; a second information recording layer including an optically transparent zone made of a transparent resin material and formed on the first information recording layer; and a protection layer formed on the second information recording layer.

A principal surface of the substrate serves as a first information surface formed with a rugged pattern corresponding to recording information. The first information recording layer includes a first reflective material film made of an optically reflective material and disposed on the principal surface.

The optically transparent zone has a second information surface formed with a rugged pattern corresponding to recording information. The second information recording layer includes a second reflective material film made of an optically reflective material and disposed on the second information surface.

Recorded information is reproduced from the two-layer optical disc in the foregoing structure, for example, by emitting laser light for reading information from the protection layer side, focusing the laser light on the first or second information recording layer, and detecting reflected light from the information recording layer.

In the reproduction of recorded information, for reading information without failure, from the first and second information recording layers, the optically transparent zone which transmits the reading laser light is required to have a uniform thickness and to be free of defects.

The two-layer optical disc is manufactured, for example, in the following procedure. First, after forming a substrate having a first information surface, a first reflective material film is deposited on the first information surface to form a first information recording layer. After a resin film made of an ultraviolet curing resin and a stamper having a surface formed with a rugged pattern corresponding to recording information are placed on the first information recording layer, the stamper is pressed onto the resin film using a pressurizing means. Ultraviolet rays are irradiated to the resin film with the stamper left in close contact with the resin film to cure the resin film, thus resulting in an optically transparent zone. The optically transparent zone is formed with a second information surface to which the rugged pattern of the stamper is transferred. After the stamper is removed, a second reflective material film is deposited on the second information surface to make a second information recording layer. A protection layer made of a resin material is formed on the second information recording layer to complete the two-layer optical disc (see, for example, Japanese Patent No. 2956989). In this manufacturing method, the second information recording layer and optically transparent zone are created by curing a resin film.

There has also been proposed a method of forming a second information recording layer and an optically transparent zone using a resin film and a liquid ultraviolet curing resin, unlike the foregoing method (see, for example, Japanese Patent No. 3460402).

First, a first reflective material film is deposited on a first information surface of a substrate to form a first information recording layer. A resin film made of an ultraviolet curing material is applied on and pressed onto the first information recording layer. After the resin film is irradiated with ultraviolet rays for curing the resin film, a liquid ultraviolet curing resin is coated on the cured resin film to form an ultraviolet curing resin film. A stamper is butted against and brought into pressure contact with the ultraviolet curing resin film, and the ultraviolet curing resin film is irradiated with ultraviolet rays with the stamper left in close contact therewith. As the stamper is removed, the resulting resin cured layer has a second information surface to which a rugged pattern of the stamper is transferred. The resin cured layer and cured resin film make up an optically transparent zone. A second reflective material film is deposited on the second information surface to form a second information recording layer. A protection film is formed on the second information recording layer to complete a two-layer optical disc.

While a two-layer optical disc can be formed by the foregoing methods, the methods have the following problems.

The ultraviolet curing resin film as mentioned above, is expensive, and therefore increases the cost required for the manufacturing of the optical disc. Also, when the resin film is brought into pressure contact with the substrate, or when the stamper is pressed onto the resin film to form the information surface, the resin film can crease, or bubbles can be introduced between the substrate and the resin film.

When a roll press machine is used to bring the substrate into pressure contact with the resin film, the substrate applied with the resin film tends to bow corresponding to the roller feeding direction. When the substrate applied with the resin film is bowed, bubbles will be introduced into the ultraviolet curing resin film when it is deposited, making the optically transparent zone more susceptible to defects, according to the manufacturing method disclosed in Japanese Patent No. 3460402. Also, the ultraviolet curing resin film cannot be made in a uniform thickness, resulting in a failure in providing the optically transparent zone in a uniform thickness.

For preventing creases, introduction of bubbles, and bowing, it is necessary to introduce an expensive and large-scaled vacuum machine.

It is an object of the present invention to provide a solution for the foregoing problems.

### SUMMARY OF THE INVENTION

A method of manufacturing a multilayer optical information recording medium according to one feature of the present invention is a method of manufacturing a multilayer optical information recording medium having at least a first and a second information recording layer on a substrate. This method is characterized by including the steps of forming the first information recording layer, applying a porous resin film on the first information recording layer, impregnating the porous resin film with a liquid functional resin, bringing a stamper into pressure contact with the porous resin film and curing the functional resin, and removing the stamper so that the second information recording layer is formed on the substrate.

A multilayer optical information recording medium according to another feature of the present invention is a multilayer optical information recording medium having at least a first and a second information recording layer. This medium is characterized in that the second information recording layer includes an optically transparent zone, where the optically transparent zone includes a functional resin, and a porous resin film having pores permeated with the functional resin.

### BRIEF DESCRIPTION OF THE DRAWINGS

FIG. 1 is a partially enlarged cross-sectional view of a multilayer optical information recording medium according to the present invention;

FIGS. 2A-2F are partially enlarged cross-sectional view for explaining a method of manufacturing the multilayer optical information recording medium according to the present invention;

FIGS. 3A-3D are partially enlarged cross-sectional view for explaining an exemplary modification to the method of manufacturing a multilayer optical recording medium according to the present invention;

FIGS. 4A and 4B are partially enlarged cross-sectional view for explaining an exemplary modification to the method of manufacturing a multilayer optical recording medium according to the present invention;

FIGS. 5A-5F are partially enlarged cross-sectional view for explaining an exemplary modification to the method of manufacturing a multilayer optical recording medium according to the present invention; and

FIGS. 6A-6E are partially enlarged cross-sectional view for explaining an exemplary modification to the method of manufacturing a multilayer optical recording medium according to the present invention.

### DETAILED DESCRIPTION OF THE INVENTION

In the following, embodiments of a method of manufacturing a multilayer optical information recording medium, and a multilayer optical information recording medium according to the present invention will be described in detail with reference to the accompanying drawings. The following embodiments will be described using a two-layer optical disc which has two information recording layers.

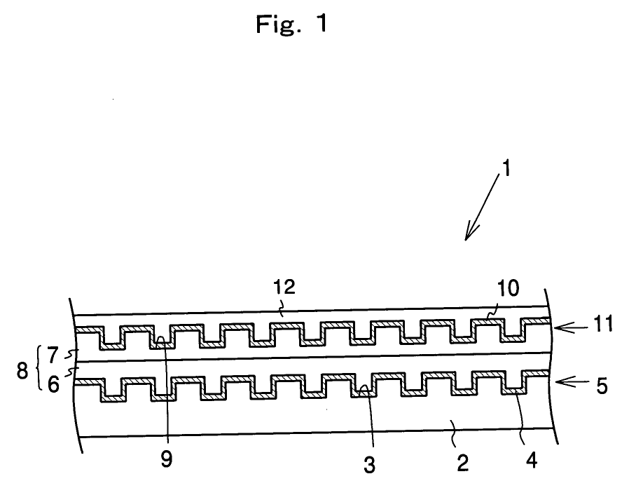

As shown in FIG. 1, a two-layer optical disc 1 according to the present invention includes a substrate 2 which has a first information surface 3 formed with a rugged pattern on one principal surface. The substrate 2 is created by injection molding a resin material such as polycarbonate (PC), polymethylmethacrylate (PMMA) or the like. The substrate 2 may be made of a transparent material such as optical glass. The rugged pattern corresponds to recording pits, pregrooves for tracking, and the like.

A first reflective material film 4 made of an optically reflective material such as gold (Au), aluminum (Al), aluminum alloy or the like is formed on the first information surface 3 of the substrate 2. A first information recording layer 5 is formed of the first reflective material film 4 and the rugged pattern of the first information surface 3. The first reflective material film 4 may be translucent.

An optically transparent zone 8 is disposed on the first information recording layer 5. The optically transparent zone 8 is composed of a porous resin film 6 which is made of an acrylic-based resin and is porous, and an ultraviolet curing resin film 7 made of an ultraviolet curing resin, which are formed in order. Pores (not shown) of the porous resin film 6 are filled with the ultraviolet curing resin which comprises the ultraviolet curing resin film 7. A principal surface of the optically transparent zone 8 opposite to the first information recording layer 5, i.e., a surface opposing the porous resin film 6 of the ultraviolet curing resin film 7, is a second information surface 9 formed with a rugged pattern. This rugged pattern also corresponds to recording pits, pre-grooves for tracking, and the like.

A second reflective material film 10 made of an optically reflective material such as an aluminum alloy is deposited on the second information surface 9. A second information recording layer 11 is formed of the second reflective material film 10 and the rugged pattern of the second information surface 9. A protection film 12 made of a resin material is formed on the second information recording layer 11. The second reflective material film 10 may be translucent.

Laser light can be directed to the two-layer optical disc 1 as descried above, for example, from the protection layer 12 side for reading recorded information.

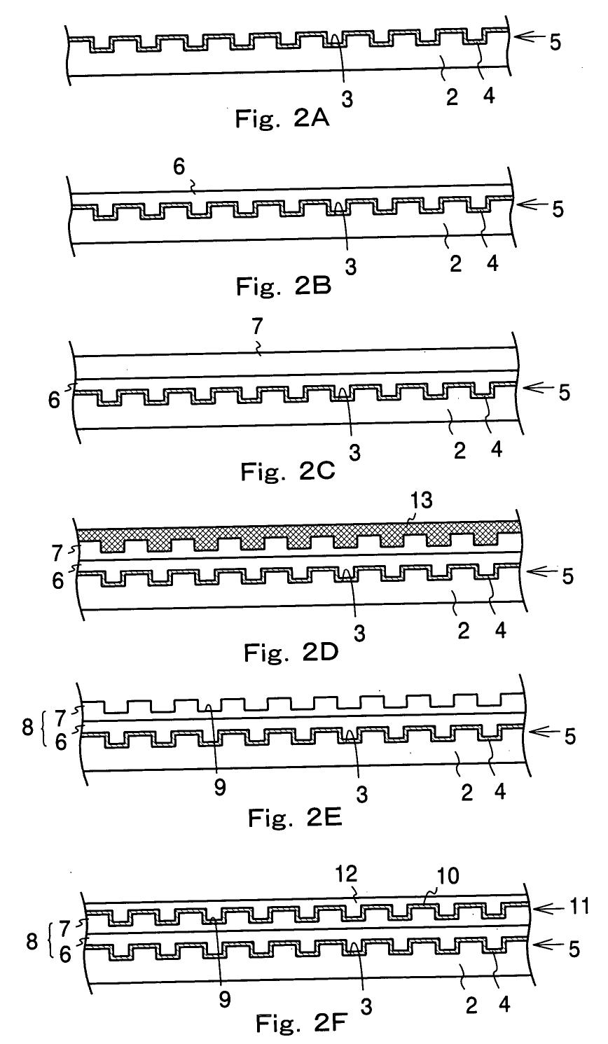

A method of manufacturing the two-layer optical disc described above will be explained with reference to a flow chart, for example, as shown in FIG. 2. As shown in FIG. 2A, after a discoidal substrate 2 having a rugged pattern on a principal surface is formed by injection molding, a first reflective material film 4 made of an aluminum alloy is deposited on the principal surface using a deposition method such as a CVD method, a sputtering method, a vapor deposition method or the like to form a first information recording layer 5.

After the first information recording layer 5 is formed, a porous resin film 6 is disposed on the substrate, as shown in FIG. 2B. The porous resin film has a porous structure which has a large number of miniature voids within the film, and can be permeated with a liquid ultraviolet curing resin component, later described. The porous structure may be, for example, a three-dimensional reticulate structure (fiber matrix). Also, the porousres in film is mainly formed of an acrylic resin, and has a uniform thickness distribution (±several μm or less).

The porous resin film preferably exhibits tackiness on at least one surface, such that the tacky surface may be adhered to the first information recording layer. A porous tacky acrylic polymer sheet (Hitalex DA100X made by Hitachi Chemical Co., Ltd.), for example, may be used for the porous film.

Also, when the porous resin film is disposed on the substrate, a roll press machine (not shown) or the like may be used to bring the porous resin film into close contact with the substrate.

After the porous resin film 6 is formed, an ultraviolet curing material film 7 is deposited on the porous resin film 6 using a method such as a spin coating method which drops a liquid ultraviolet curing resin, while the substrate is rotated (FIG. 2C). The liquid ultraviolet curing resin preferably contains an acrylic-based resin as a main component (for example, MP121 made by Mitsubishi Rayon Co., Ltd. can be used). Also, the liquid ultraviolet curing resin preferably contains a polymerization initiator, and an acetophenone derivative, for example, can be used for the polymerization initiator. The liquid ultraviolet curing resin is applied on the porous resin film, allowing the ultraviolet curing resin to permeate into the porous structure of the porous resin film 6.

After the ultraviolet curing resin permeates into the porous resin film 6, a stamper 13 (for example, a nickel stamper) previously formed with a miniature rugged pattern is butted against the liquid ultraviolet curing resin film 7 to transfer the rugged pattern to the ultraviolet curing resin film 7 (FIG. 2D).

In the transfer, the substrate may be rotated with the stamper 13 being left butted against the ultraviolet curing resin film 7. For example, the substrate may be placed on a rotating means (not shown) for rotation, with the rotating shaft of the rotating means extending through the center of the substrate at right angles to the principal surface of the substrate. The rotation can remove the liquid ultraviolet curing resin from between the stamper and the porous resin film by the action of a centrifugal force, so that the ultraviolet curing resin film can be created in a desired thickness. In addition, the thickness of the ultraviolet curing resin film can be controlled by controlling the rotational speed and a rotation time of the rotating means.

Also, the step of transferring the rugged pattern of the stamper may include the step of bringing the stamper 13 into pressure contact with the ultraviolet curing resin film 7 using, for example, a roll press machine (not shown).

With the stamper 13 left in close contact with the ultraviolet curing resin film 7, the ultraviolet curing resin film 7 is irradiated with ultraviolet rays from the substrate side using ultraviolet irradiation equipment (not shown). In this way, the ultraviolet curing resin is cured. When the stamper 13 is made of a transparent material, ultraviolet rays may be irradiated from the stamper 13 side.

As shown in FIG. 2E, the stamper 13 is removed from the cured ultraviolet curing resin film 7, resulting in the formation of an optically transparent zone 8 composed of the ultraviolet curing resin film 7 formed with a second information surface 9 corresponding to the rugged pattern of the stamper 13, and the porous resin film 6.

A second reflective material film 10 made of an aluminum alloy or the like is deposited on the second information surface 9 using a deposition method such as a vapor deposition method to form a second information recording layer 11. Further, a protection layer 12 made of a resin material is formed on the second information recording layer 11 to complete a two-layer optical disc (FIG. 2F).

According to the method of manufacturing an optical disc as described above, no void is formed in the optically transparent zone. Specifically, even if voids are formed between the porous resin film and the substrate when the porous resin film is applied to the substrate, the voids are filled with the liquid ultraviolet curing resin component by allowing the liquid ultraviolet curing resin to permeate into the porous resin film, so that the optically transparent zone is free of voids.

Also, even if the porous resin film creases when it is applied to the substrate, the ultraviolet curing resin film can be formed to cover the creases, so that the optically transparent zone is also free of creases.

Further, by allowing the liquid ultraviolet curing resin to permeate into the porous resin film, a stress accumulated when the resin film is applied to the substrate can be alleviated. As a result, the formed optical disc will not be bowed.

Since the optical disc is free of voids, creases, and bowing, a large- scaled vacuum machine need not be provided, as has been required in the prior art. As a result, a time otherwise required for a vacuum step can be saved in addition to a reduction in the cost and space required for the manufacturing machine.

Also, according to the manufacturing method as described above, since the optically transparent zone can be previously formed using a resin film in a uniform thickness, the thickness of the optically transparent zone can also be made uniform.

Further, in the formation of the optically transparent zone, with the user of the porous resin film having a porous structure (for example, a three-dimensional reticulate structure), the optically transparent zone can be formed even with a small amount of a polymerization initiator required for curing the liquid ultraviolet curing resin. It is therefore possible to reduce the concentration of the polymerization initiator contained in the formed optical disc, thus reducing the absorption of light (for example, light near wavelength of 400 nm) by the polymerization initiator, i.e., a loss of light transmittance. As described above, even if a multilayer optical disc is manufactured by reducing the loss of light transmittance, only small power of light is required to read information from the multilayer optical disc.

The step of forming the optically transparent zone may be a step of dropping the liquid ultraviolet curing resin on the stamper to form an ultraviolet curing resin film, and butting the ultraviolet curing resin film against the porous resin film.

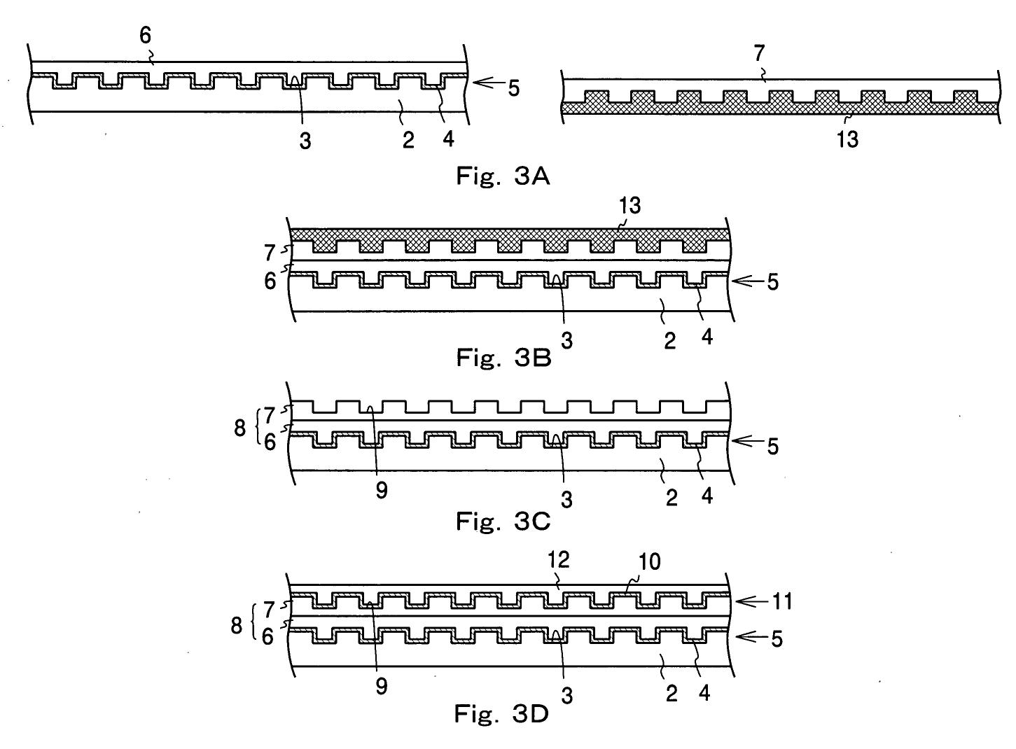

Specifically, as shown in FIG. 3A, a step of forming the porous resin film 6 on the substrate 2 having the first information recording layer 5 is executed separately from the step of forming the ultraviolet curing resin film 7 on the stamper 13. Subsequently, the ultraviolet curing resin film 7 disposed on the stamper 13 is adhered to the porous resin film 6 (FIG. 3B). After the component of the ultraviolet curing resin film 7 is allowed to permeate into the porous resin film 6, the film is irradiated with ultraviolet rays to cure the ultraviolet curing resin film 7.

As shown in FIG. 3C, the stamper 13 is removed from the ultraviolet curing resin film 7, resulting in the formation of the ultraviolet curing resin film 7 formed with the second information surface 9 corresponding to the rugged pattern of the stamper 13, and the porous resin film 6.

The second reflective material film 10 made of an aluminum alloy or the like is deposited on the second information surface 9 by a deposition method such as a vapor deposition method to form the second information recording layer 11 including the second reflective material film 10 and second information surface 9. Further, the protection layer 12 made of a resin material is formed on the second information recording layer 11 to complete a two-layer optical disc (FIG. 3D).

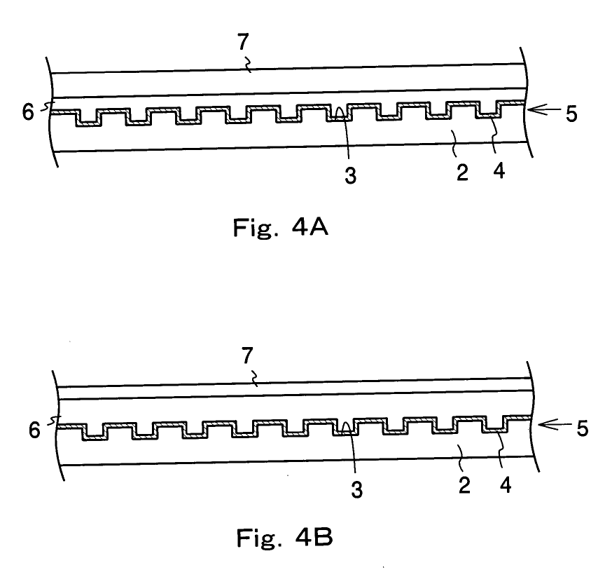

As an exemplary modification, the porous resin film may be made of a material which expands as it is permeated with the liquid ultraviolet curing resin. For example, as shown in FIG. 4A, a liquid acrylic ultraviolet curing resin is applied to a porous resin film 6 made of a porous acrylic polymer sheet to form an ultraviolet curing resin film 7. As the liquid resin permeates into the porous resin film 6, the thickness of the film may increase through expansion (FIG. 4B). As described above, the optically transparent zone can be formed in a uniform thickness through the expansion of the porous resin film by the permeation of the liquid ultraviolet curing resin thereinto.

Also, as an exemplary modification, the porous resin film may include an organic compound which has a polymeric unsaturated bond, for example, a compound having a double bond or the like. By polymerization of the organic compound with the ultraviolet curing resin, the porous film can be chemically bonded with the ultraviolet curing resin.

The step of applying the porous resin film on the first information recording layer may include a step of forming an adhesive film on the first information recording layer, and a step of applying the porous resin film on the adhesive film. With the provision of the adhesive film, the porous resin film can be secured to the first information recording layer.

The adhesive film may be made, for example, of a liquid ultraviolet curing resin. With the use of such an adhesive film, the porous resin film can be permeated with the component of the adhesive film, thereby preventing voids from being formed between the porous resin film and the first information recording layer.

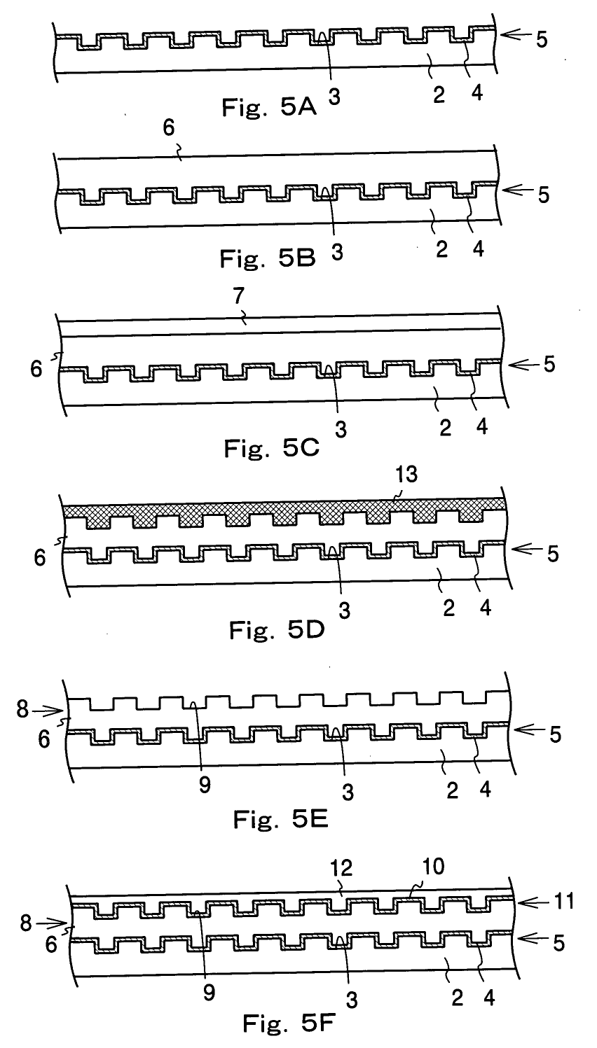

The optically transparent zone may not include the ultraviolet curing resin film but may consist only of the porous resin film which has pores filled with the ultraviolet curing resin. The manufacturing of the two-layer optical disc having such an optically transparent zone includes a step of forming the porous resin film 6 on the substrate 2 having the first information recording layer 5, for example, as shown in FIG. 5A and FIG. 5B.

A liquid ultraviolet curing resin is applied on the porous resin film 6, such that the liquid ultraviolet curing resin is allowed to permeate into the porous resin film 6 (FIG. 5C). After the impregnation, the stamper 13 is brought into pressure contact with the porous resin film 6, and the porous resin film 6 is irradiated with ultraviolet rays to cure the porous resin film 6 (FIG. 5D).

As shown in FIG. 5E, the stamper 13 is removed from the porous resin film 6, resulting in the formation of the optically transparent zone 8 consisting of the porous resin film 6 formed with the second information surface 9 corresponding to the rugged pattern of the stamper 13.

A second reflective material layer 10 made of an aluminum alloy or the like is deposited on the second information surface 9 using a deposition method such as a vapor deposition method to form a second information recording layer 11 which includes the second reflective material film 10 and second information surface 9. The protection layer 12 made of a resin material is further formed on the second information recording layer 11 to complete the two-layer optical disc (FIG. 5F).

While the foregoing embodiment has been described in connection with a two-layer optical disc, the present invention is not limited to the two-layer optical disc. The present invention can also be applied to the manufacturing of a multilayer optical information recording medium having three or more information recording layers by repeating the step of disposing the porous resin film, ultraviolet curing resin, and stamper on the surface of the information recording layer in order, and depositing the reflective material film on the information surface by the stamper to form the optically transparent zone having the information recording layer.

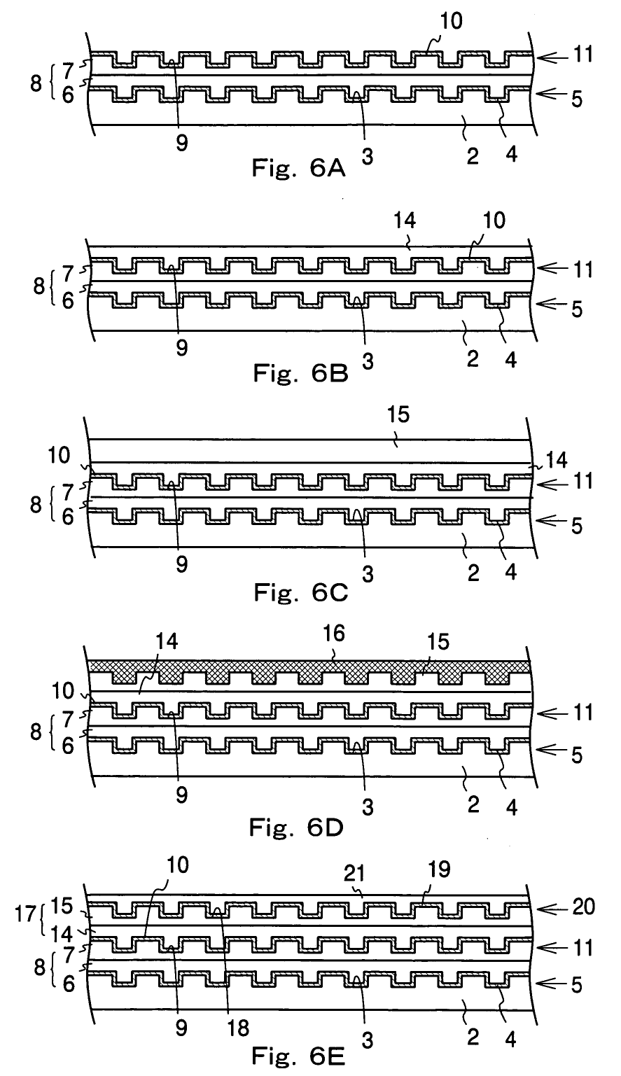

For example, a method of manufacturing a three-layer optical disc will be described with reference to a flow chart as shown in FIG. 6. With a substrate (FIG. 6A) having formed thereon a first information recording layer 5, a first optically transparent zone 8 composed of a first porous resin film 6 and a first ultraviolet curing resin film 7, and a second information recording layer 11, a porous resin film is applied on the second information recording layer 11 to form a second porous resin film 14 (FIG. 6B).

A second ultraviolet curing resin film 15 is formed on the second porous resin film 14 using a liquid ultraviolet curing resin, such that the second porous resin film 14 is permeated with the ultraviolet curing resin (FIG. 6C).

A stamper 16 is butted against the second ultraviolet curing resin 15, and ultraviolet rays are irradiated to cure the second ultraviolet curing resin 15. The second porous resin film 14 and second ultraviolet curing resin film 15 make up a second optically transparent zone 17 (FIG. 6D).

After removing the stamper, a third reflective material film 19 is deposited on a third information surface 18 provided on the second optically transparent zone 17 to form a third information recording layer 20. A protection layer 21 is formed on the third information recording layer 20 to complete a three-layer optical disc (FIG. 6E).

In the foregoing embodiment, while the optically transparent zone is made of a liquid ultraviolet curing resin which is irradiated with ultraviolet rays for curing, the optically transparent zone is not limited to this material, but a functional resin may be used including a visible light curing resin, a thermosetting resin, and a curable resin mixed with a curing agent. In other words, the resin curing method can be used for any resin material as long as it is transparent at a wavelength of a light source included in an optical pickup for use in recording and reproducing recording information.

The information recording layers used in the multilayer optical recording medium are not limited to those including a reflective material film exclusively for reproduction. For example, a write-once information recording layer including organic pigment materials such as cyanine-based and phthalocyanine-based materials and the like, and an alloy material of a low-melting point metal such as Te, Bi, Se, Sn and the like, and a phase change type information recording layer including a phase change material such as GeInSbTe-based, AgIbSbTe-based, GeSbTe-based materials and the like may be applied to the multilayer optical recording medium. Further, the shape of the multilayer optical recording medium is not limited to a discoidal shape, but may be, for example, in a card shape.

According to a method of manufacturing a multilayer optical information recording medium having at least a first and a second information recording layer on a substrate characterized by including the steps of forming the first information layer, applying a porous resin film on the first information recording layer, impregnating the porous resin film with a liquid functional resin, bringing a stamper into pressure contact with the porous resin film and curing the functional resin for transfer, and removing the stamper to form the second information recording layer, since the porous resin film can be permeated with the liquid ultraviolet curing resin, the component of the liquid ultraviolet curing resin can be filled in voids formed between the porous resin film and the first information recording layer. As a result, no defects will occur between the first information recording layer and the second information recording layer.

According to a multilayer optical information recording medium having at least a first and a second information recording layer of the present invention characterized in that an optically transparent zone included in the second information recording layer includes a functional resin and a porous resin film having pores permeated with the functional resin, since the cost required for the material for making the recording medium can be reduced, the multilayer information recording medium can be provided at a low price.

This application is based on a Japanese patent application No. 2004-95853 which is hereby incorporated by reference.

1. A method of manufacturing a multilayer optical information recording medium having at least a first and a second information recording layer on a substrate, said method comprising the steps of:
forming said first information recording layer;
applying a porous resin film on said first information recording layer;
impregnating said porous resin film with a liquid functional resin; bringing a stamper into pressure contact with said porous resin film and curing said functional resin; and removing said stamper so that said second information recording layer is formed on said substrate.

2. A method of manufacturing a multilayer optical information recording medium according to claim 1, wherein said porous resin film is expanded by the impregnation of said liquid functional resin thereinto.

3. A method of manufacturing a multilayer optical information recording medium according to claim 1, wherein said porous resin film is an acrylic-based resin.

4. A method of manufacturing a multilayer optical information recording medium according to claim 1, wherein said porous resin film includes an organic compound having a polymeric unsaturated bond.

5. A method of manufacturing a multilayer optical information recording medium according to claim 1, wherein said step of impregnating said porous resin film with said liquid functional resin includes the step of applying said liquid functional resin on said porous resin film.

6. A method of manufacturing a multilayer optical information recording medium according to claim 1, wherein said step of impregnating said porous resin film with said liquid functional resin includes butting said stamper applied with said liquid functional resin against said porous resin film.

7. A method of manufacturing a multilayer optical information recording medium according to claim 1, wherein said step of bringing said stamper into pressure contact with said porous resin film includes the step of applying a centrifugal force to said stamper and said substrate while said porous resin film is butted against said stamper.

8. A method of manufacturing a multilayer optical information recording medium according to claim 1, wherein said step of applying said porous resin film includes the steps of forming an adhesive film on said first information recording layer, and applying said porous resin film on said adhesive film.

9. A method of manufacturing a multilayer optical information recording medium according to claim 1, wherein:
said liquid functional resin is a liquid photo-curing resin, and said transfer step includes the step of irradiating said liquid photo-curing resin with light.

10. A method of manufacturing a multilayer optical information recording medium according to claim 9, wherein said liquid photo-curing resin mainly contains an acrylic-based resin.

11. A method of manufacturing a multilayer optical information recording medium according to claim 9, wherein said liquid photo-curing resin includes a polymerization initiator comprising an acetophenone derivative.

12. A multilayer optical information recording medium having at least a first and a second information recording layer, comprising:
said second information recording layer including an optically transparent zone,
wherein said optically transparent zone includes a functional resin, and a porous resin film having pores permeated with said functional resin.

13. A multilayer optical information recording medium according to claim 12, wherein said porous resin film is an acrylic-based resin.

14. A multilayer optical information recording medium according to claim 12, wherein said functional resin is a photo-curing resin.
